(19) United States
(12) Patent Application Publication
(10) Pub. No.: US 2026/0121829 A1
(43) Pub. Date: Apr. 30, 2026

(54) CONFIDENTIAL INFORMATION PROCESSING SYSTEM, CONFIDENTIAL INFORMATION PROCESSING METHOD, AND NON-TRANSITORY COMPUTER-READABLE MEDIUM

(71) Applicant: Mitsubishi Electric Corporation, Tokyo (JP)

(72) Inventor: Ryo HIROMASA, Tokyo (JP)

(73) Assignee: Mitsubishi Electric Corporation, Tokyo (JP)

(21) Appl. No.: 18/929,750

(22) Filed: Oct. 29, 2024

Related U.S. Application Data
(63) Continuation of application No. PCT/JP2022/023823, filed on Jun. 14, 2022.

(51) Int. Cl. H04L 9/00; H04L 9/08; H04L 9/30

(52) U.S. Cl. CPC H04L 9/008; H04L 9/0825; H04L 9/0852; H04L 9/0863; H04L 9/0869; H04L 9/30

(57) ABSTRACT

A confidential information processing system conforming to a quantum homomorphic cryptographic technique that satisfies strong circuit confidentiality includes an encryption device (400). The encryption device (400) includes an encryption unit (404) that generates a first ciphertext by encrypting a first plaintext, using a first public parameter and a first encryption key, and generates a second ciphertext by encrypting a second plaintext, using a second public parameter and a second encryption key. Each of the first public parameter and the second public parameter is a parameter generated using a security parameter. The first encryption key is an encryption key generated using the first public parameter and a first decryption key which is a decryption key generated using the security parameter. The second encryption key is an encryption key generated using the second public parameter and a second decryption key which is a decryption key generated using the security parameter.

### CROSS REFERENCE TO RELATED APPLICATIONS

This application is a Continuation of PCT International Application No. PCT/JP2022/023823, filed on Jun. 14, 2022, which is hereby expressly incorporated by reference into the present application.

### TECHNICAL FIELD

The present disclosure relates to a confidential information processing system, a confidential information processing method, and a confidential information processing program.

### BACKGROUND ART

Quantum homomorphic encryption is a cryptographic technique that can perform a quantum arithmetic operation while keeping data encrypted. Recently, although the use of cloud services is widespread, due to cracking, concerns about the reliability of a cloud, or the like, it is considered to encrypt data and store the data in the cloud. The quantum homomorphic encryption can perform an arithmetic operation on encrypted data without decrypting the encrypted data. Therefore, the quantum homomorphic encryption is a technique that enables the use of cloud services, using quantum computation without compromising security.

A cryptographic technique for improving the security of quantum homomorphic encryption, the cryptographic technique that achieves the security of not leaking information about arithmetic processing from a result of a quantum arithmetic operation while keeping data encrypted is quantum homomorphic encryption that satisfies circuit confidentiality. In particular, among pieces of quantum homomorphic encryption that satisfy circuit confidentiality, quantum homomorphic encryption that achieves the security of not leaking information about quantum arithmetic operation from a result of a quantum homomorphic arithmetic operation on a ciphertext that has not been generated by an encryption algorithm is quantum homomorphic encryption that satisfies strong circuit confidentiality. The quantum homomorphic encryption that satisfies the strong circuit confidentiality is implemented, when an arithmetic operation is executed on encrypted data, by executing the arithmetic operation while keeping the data encrypted by the quantum homomorphic encryption that satisfies the normal circuit confidentiality after checking the validity of the input. Specifically, the validity of the input is that an encryption key which is the input of the arithmetic operation is generated by a key generation algorithm, and a ciphertext which is the input of the arithmetic operation is generated by an encryption algorithm. The quantum homomorphic encryption that satisfies the normal circuit confidentiality is quantum homomorphic encryption in which the circuit confidentiality is valid only for a ciphertext generated by the encryption algorithm.

Non-Patent Literature 1 discloses a configuration example of the quantum homomorphic encryption that satisfies the storing circuit confidentiality, and also discloses a configuration example of the quantum homomorphic encryption that satisfies the strong circuit confidentiality and that can execute a homomorphic arithmetic operation on ciphertexts encrypted using encryption keys that differ from each other.

### CITATION LIST

### Non-Patent Literature

Non-Patent Literature 1: Chardouvelis, O. et al., “Rate-1 Quantum Fully Homomorphic Encryption”, TCC 2021: Theory of Cryptography, pp. 149-176, 2021.

### SUMMARY OF INVENTION

### Technical Problem

The conventional quantum homomorphic encryption that satisfies the circuit confidentiality disclosed in Non-Patent Document 1 uses a special computational problem called the Decisional Small Polynomial Ratio (DSPR) problem as the basis for security. However, it is known that the DSPR problem can be easily solved by using a quantum computer. In particular, in the quantum homomorphic cryptographic technique disclosed in Non-Patent Document 1, the security of homomorphic encryption that satisfies the circuit confidentiality used as a configuration component depends on the difficulty of the DSPR problem. Therefore, the quantum homomorphic encryption that satisfies the strong circuit confidentiality disclosed in Non-Patent Document 1 is also not secure for a quantum computer.

The present disclosure aims to realize quantum homomorphic cryptographic technique that satisfies strong circuit confidentiality that is secure for a quantum computer and enables a homomorphic operation by quantum computation between ciphertexts encrypted by encryption keys that differ from each other.

### Solution to Problem

A confidential information processing system according to the present disclosure conforming to a quantum homomorphic cryptographic technique that satisfies strong circuit confidentiality, the confidential information processing system includes
an encryption device that includes an encryption unit to generate a first ciphertext by encrypting a first plaintext, using a first public parameter and a first encryption key, and to generate a second ciphertext by encrypting a second plaintext, using a second public parameter and a second encryption key, wherein
each of the first public parameter and the second public parameter is a parameter generated using a security parameter,
the first encryption key is an encryption key generated using the first public parameter and a first decryption key which is a decryption key generated using the security parameter, and
the second encryption key is an encryption key generated using the second public parameter and a second decryption key which is a decryption key generated using the security parameter.

### Advantageous Effects of Invention

According to the present disclosure, it is possible to realize quantum homomorphic cryptographic technique that satisfies strong circuit confidentiality that is secure for a quantum computer and enables a quantum homomorphic operation by quantum computation between ciphertexts encrypted by encryption keys that differ from each other.

### BRIEF DESCRIPTION OF DRAWINGS

FIG. 1 is a diagram illustrating a configuration example of a confidential information processing system 100 according to Embodiment 1.

FIG. 2 is a diagram illustrating a configuration example of a public parameter generation device 200 according to Embodiment 1.

FIG. 3 is a diagram illustrating a configuration example of a key generation device 300 according to Embodiment 1.

FIG. 4 is a diagram illustrating a configuration example of an encryption device 400 according to Embodiment 1.

FIG. 5 is a diagram illustrating a configuration example of a homomorphic arithmetic operation device 500 according to Embodiment 1.

FIG. 6 is a diagram illustrating a configuration example of a decryption device 600 according to Embodiment 1.

FIG. 7 is a diagram illustrating a hardware configuration example of each device according to Embodiment 1.

FIG. 8 is a flowchart illustrating operation of the confidential information processing system 100 according to Embodiment 1.

FIG. 9 is a flowchart illustrating the operation of the confidential information processing system 100 according to Embodiment 1.

FIG. 10 is a flowchart of illustrating the operation of the confidential information processing system 100 according to Embodiment 1.

FIG. 11 is a diagram illustrating a hardware configuration example of each device according to a modification of Embodiment 1.

### DESCRIPTION OF EMBODIMENTS

In the description and drawings of embodiments, the same elements and corresponding elements are denoted by the same reference sign. The description of elements denoted by the same reference sign will be suitably omitted or simplified. Arrows in the drawings mainly indicate flows of data or flows of processing. Further, “unit” may be suitably interpreted as “device”, “circuit”, “process”, “procedure”, “process”, “step” or “circuitry”.

### Embodiment 1

The present embodiment will be described in detail below with reference to the drawings.

### Description of Configuration

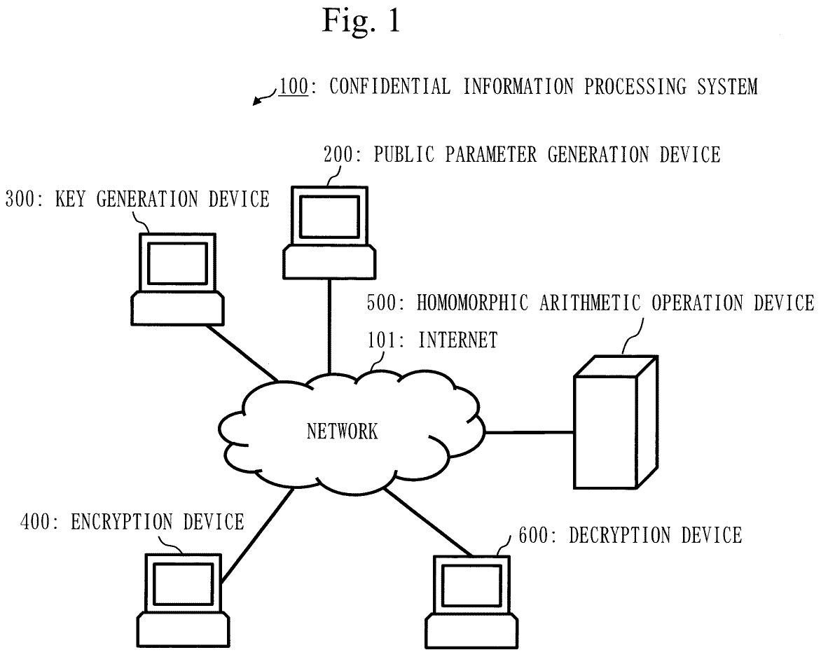

FIG. 1 illustrates a system configuration example of a confidential information processing system 100 according to the present embodiment. The confidential information processing system 100 includes a public parameter generation device 200, a key generation device 300, an encryption device 400, a homomorphic arithmetic operation device 500, and a decryption device 600, as illustrated in FIG. 1

Internet 101 is a communication path that connects the public parameter generation device 200, the key generation device 300, a plurality of encryption devices 400, the homomorphic arithmetic operation device 500, and the decryption device 600. The Internet 101 is a specific example of a network. Another type of network may be used instead of the Internet 101.

A specific example of the public parameter generation device 200 is a Personal Computer (PC). The public parameter generation device 200 generates a public parameter used to generate each of an encryption key, a decryption key, and a ciphertext, and transmits data indicating the generated public parameter to each of the key generation device 300, the encryption device 400, and the homomorphic arithmetic operation device 500 via the Internet 101. The data indicating the generated public parameter may be sent directly by mail or the like.

A specific example of the key generation device 300 is a PC. The key generation device 300 generates each of an encryption key used for encryption and a decryption key, transmits data indicating the generated encryption key to each of the encryption device 400 and the homomorphic arithmetic operation device 500 via the Internet 101, and transmits data indicating the generated decryption key to the decryption device 600. The data indicating each generated key may be sent directly by mail or the like.

Since the decryption key is secret information, the decryption key is stored in each of the key generation device 300 and the decryption device 600 to prevent leakage.

A specific example of the encryption device 400 is a PC. The encryption device 400 generates ciphertext data by encrypting plaintext data obtained from a sensor or the like of a factory, using a stored public parameter and a stored encryption key, and transmits the generated ciphertext data to the homomorphic arithmetic operation device 500 via the Internet 101.

A specific example of the homomorphic arithmetic operation device 500 is a computer having a large capacity storage medium. The homomorphic arithmetic operation device 500 is also referred to as a circuit confidential quantum homomorphic arithmetic operation device.

The homomorphic arithmetic operation device 500 also functions as a data storage device. That is, upon receiving a storage request for ciphertext data from the encryption device 400, the homomorphic arithmetic operation device 500 stores the ciphertext data corresponding to the storage request.

The homomorphic arithmetic operation device 500 also functions as a device that performs a homomorphic arithmetic operation on stored ciphertext data which is ciphertext data stored. That is, the homomorphic arithmetic operation device 500 generates from a stored public parameter, a stored encryption key, and a stored ciphertext data, ciphertext data corresponding to an arithmetic operation result on plaintext data corresponding to the stored ciphertext data, and transmits the generated ciphertext data to the decryption device 600 via the Internet 101.

A specific example of the decryption device 600 is a PC. The decryption device 600 also functions as a decryption key storage device that receives data indicating a decryption key transmitted by the key generation device 300 and stores the decryption key indicated in the received data.

The decryption device 600 is also a PC that operates as a ciphertext data decryption device that receives ciphertext data transmitted by the homomorphic arithmetic operation device 500 and obtains an arithmetic operation result by decrypting the received ciphertext data, using a stored decryption key.

At least two of the public parameter generation device 200, the key generation device 300, the encryption device 400, the homomorphic arithmetic operation device 500, and the decryption device 600 may be included in the same PC at the same time.

A configuration of the present embodiment will be described below. The number of elements generated by each device may be two or more.

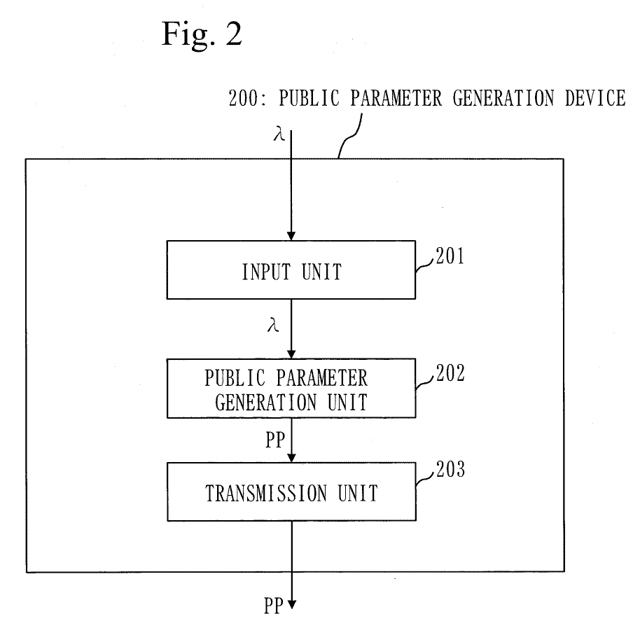

FIG. 2 is a block diagram illustrating a configuration example of the public parameter generation device 200. The public parameter generation device 200 includes an input unit 201, a public parameter generation unit 202, and a transmission unit 203, as illustrated in FIG. 2. Although it is not illustrated, the public parameter generation device 200 includes a storage medium that stores data used in each unit of the public parameter generation device 200.

The input unit 201 receives data indicating a security parameter λ, and transmits the received data indicating the security parameter λ to the public parameter generation unit 202.

The public parameter generation unit 202 takes the security parameter λ indicated in the data received from the input unit 201, as input, and generates a public parameter PP which is a parameter for generating each of an encryption key and a decryption key. After that, the public parameter generation unit 202 transmits data indicating the generated public parameter PP to the transmission unit 203.

The transmission unit 203 transmits to each of the key generation device 300, the encryption device 400, and the homomorphic arithmetic operation device 500, the data indicating the public parameter PP generated by the public parameter generation unit 202.

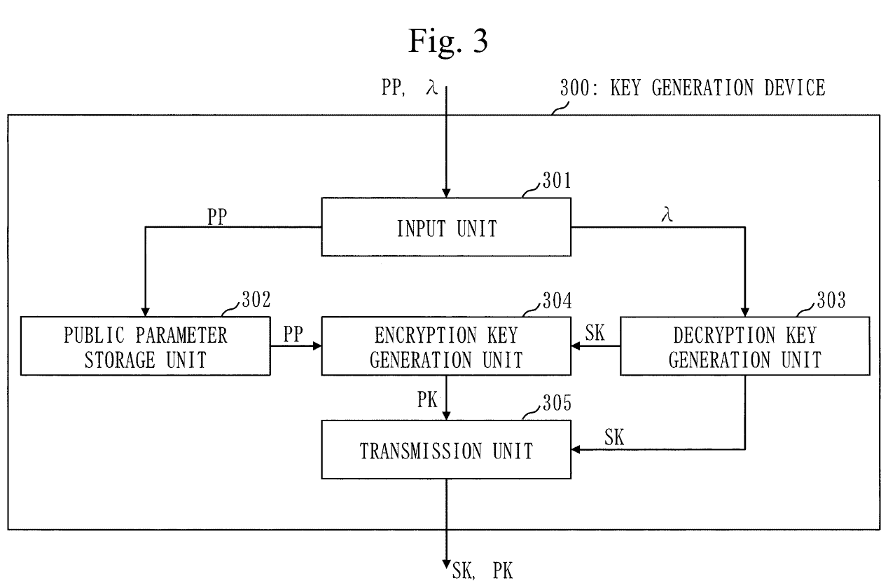

FIG. 3 is a block diagram illustrating a configuration example of the key generation device 300. The key generation device 300 includes an input unit 301, a public parameter storage unit 302, a decryption key generation unit 303, an encryption key generation unit 304, and a transmission unit 305, as illustrated in FIG. 3. Although it is not illustrated, the key generation device 300 includes a storage medium that stores data used in each unit of the key generation device 300.

The input unit 301 receives the data indicating the public parameter PP transmitted by the public parameter generation device 200, and transmits the public parameter PP indicated in the received data to the public parameter storage unit 302.

Further, the input unit 301 receives the data indicating the security parameter λ, and transmits the received data indicating the security parameter λ to the decryption key generation unit 303.

The public parameter storage unit 302 stores the public parameter PP indicated in the data received from the input unit 301.

The decryption key generation unit 303 generates a decryption key SK, using the security parameter λ indicated in the data received from the input unit 301, and transmits data indicating the generated decryption key SK to each of the encryption key generation unit 304 and the transmission unit 305.

The encryption key generation unit 304 takes the public parameter PP indicated in the data received from the public parameter storage unit 302 and the decryption key SK indicated in the data received from the decryption key generation unit 303, as input, to generate an encryption key PK, and transmits data indicating the generated encryption key PK to the transmission unit 305.

The encryption key generation unit 304 generates a first encryption key, using a first public parameter and a first decryption key, and generates a second encryption key, using a second public parameter and a second decryption key. Here, each of the first public parameter and the second public parameter is a parameter generated using the security parameter λ. Each of the first decryption key and the second decryption key is a decryption key generated using the security parameter λ.

The transmission unit 305 transmits to the decryption device 600, data indicating the decryption key SK generated by the decryption key generation unit 303.

Further, the transmission unit 305 transmits to each of the encryption device 400 and the homomorphic arithmetic operation device 500, the data indicating the encryption key PK generated by the encryption key generation unit 304.

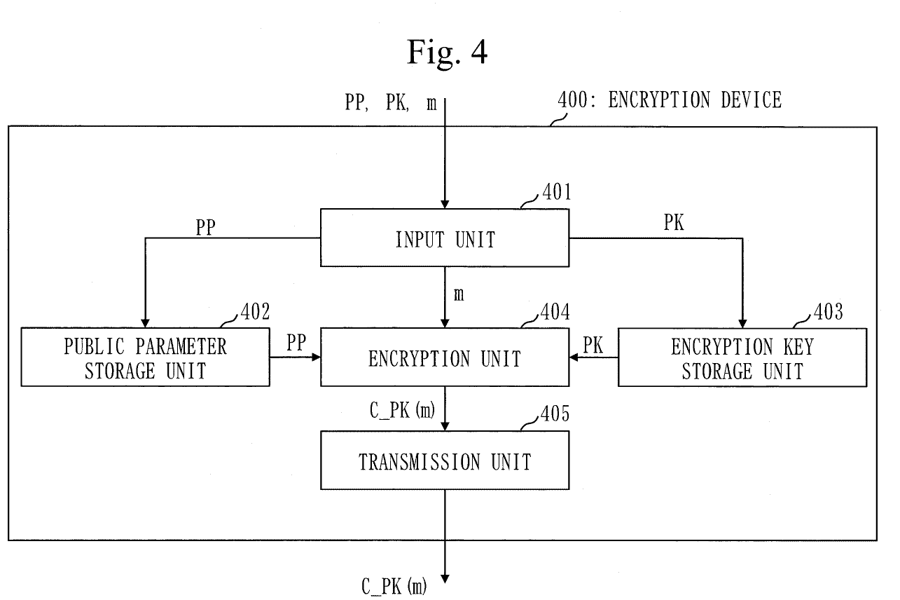

FIG. 4 is a block diagram illustrating a configuration example of the encryption device 400. The encryption device 400 includes an input unit 401, a public parameter storage unit 402, an encryption key storage unit 403, an encryption unit 404, and a transmission unit 405, as illustrated in FIG. 4. Although it is not illustrated, the encryption device 400 includes a recording medium that stores data used in each unit of the encryption device 400.

The input unit 401 receives the data indicating the public parameter PP transmitted by the public parameter generation device 200, and transmits the received data indicating the public parameter PP to the public parameter storage unit 402.

Further, the input unit 401 receives the data indicating the encryption key PK transmitted by the key generation device 300, and transmits the received data indicating the encryption key PK to the encryption key storage unit 403.

Further, the input unit 401 receives plaintext data m, and transmits the received plaintext data m to the encryption unit 404.

The public parameter storage unit 402 stores the public parameter PP indicated in the data received from the input unit 401.

The encryption key storage unit 403 stores the encryption key PK indicated in the data received from the input unit 401.

The encryption unit 404 generates ciphertext data C_PK(m) corresponding to the plaintext data m, using the public parameter PP received from the public parameter storage unit 402, the encryption key PK received from the encryption key storage unit 403, and the plaintext data m received from the input unit 401, and transmits the generated ciphertext data C_PK(m) to the transmission unit 405. Hereinafter, ciphertext data obtained by encrypting the plaintext data m, using the encryption key PK will be referred to as the ciphertext data C_PK(m).

The encryption unit 404 generates a first ciphertext by encrypting a first plaintext, using the first public parameter and the first encryption key, and generates a second ciphertext by encrypting a second plaintext, using the second public parameter and the second encryption key.

The transmission unit 405 receives the ciphertext data C_PK(m) from the encryption unit 404, and transmits the received ciphertext data C_PK(m) to the homomorphic arithmetic operation device 500.

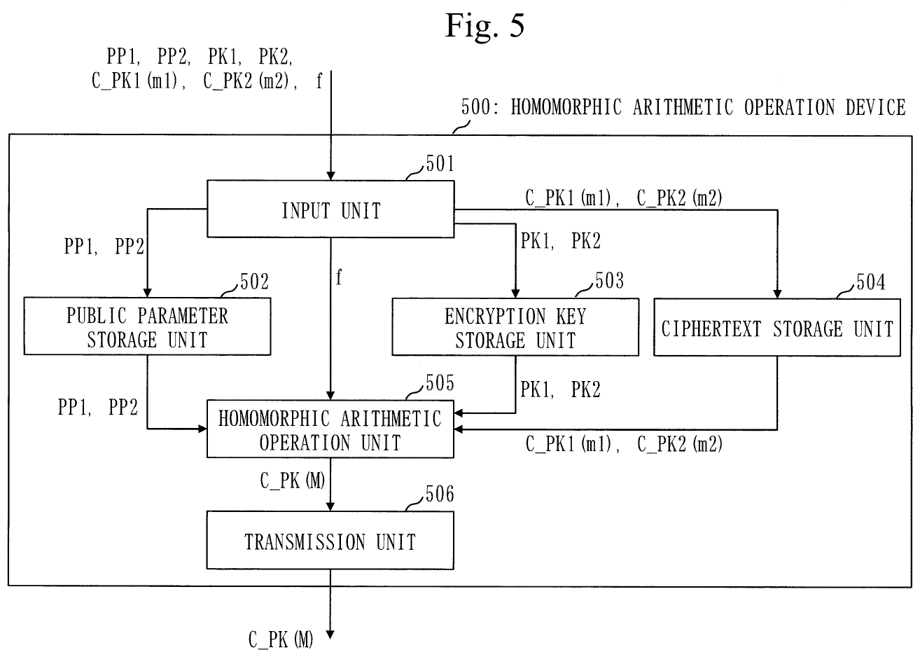

FIG. 5 is a block diagram illustrating a configuration example of the homomorphic arithmetic operation device 500. The homomorphic arithmetic operation device 500 includes an input unit 501, a public parameter storage unit 502, an encryption key storage unit 503, a ciphertext storage unit 504, a homomorphic arithmetic operation unit 505, and a transmission unit 506, as illustrated in FIG. 5. Although it is not illustrated, the homomorphic arithmetic operation device 500 includes a recording medium that stores data used in each unit of the homomorphic arithmetic operation device 500.

The input unit 501 receives data indicating a public parameter PP1 and data indicating a public parameter PP2, transmitted by the public parameter generation device 200, and transmits to the public parameter storage unit 502, the received data indicating the public parameter PP1 and the received data indicating the public parameter PP2. Here, the number given at the end of the symbol indicating each element is a notation for distinguishing a plurality of existing elements of the same type from each other. Regarding the public parameter PP1 and the public parameter PP2, 1 or 2 is given to the end for distinguishing two public parameters PP generated by the public parameter generation device 200, as a specific example. Further, the public parameter PP1 corresponds to the first public parameter. The public parameter PP2 corresponds to the second public parameter.

Further, the input unit 501 receives data indicating an encryption key PK1 and data indicating an encryption key PK2, transmitted by the key generation device 300, and transmits to the encryption key storage unit 503, the received data indicating the encryption key PK1 and the received data indicating the encryption key PK2. Here, the encryption key PK1 corresponds to the first encryption key. The encryption key PK2 corresponds to the second encryption key. The first encryption key consists of a first homomorphic public key generated based on a first homomorphic decryption key and a first quantum homomorphic public key generated based on a first quantum homomorphic decryption key. The second encryption key consists of a second homomorphic public key generated based on a second homomorphic decryption key and a second quantum homomorphic public key generated based on a second quantum homomorphic decryption key.

Further, the input unit 501 receives ciphertext data C_PK(m1) and ciphertext data C_PK(m2) transmitted by the encryption device 400, and transmits the received ciphertext data C_PK(m1) and the received ciphertext data C_PK(m2) to the ciphertext storage unit 504. Here, plaintext data m1 corresponds to the first plaintext. Plaintext data m2 corresponds to the second plaintext. The ciphertext data C_PK(m1) corresponds to the first ciphertext. The ciphertext data C_PK(m2) corresponds to the second ciphertext. The first ciphertext is a ciphertext generated based on the first public parameter, a first one-time pad key, the first homomorphic public key, the first quantum homomorphic public key, and a first random number. The second ciphertext is a ciphertext generated based on the second public parameter, a second one-time pad key, the second homomorphic public key, the second quantum homomorphic public key, and a second random number.

Further, the input unit 501 receives data indicating an arithmetic operation circuit f, and transmits the received data indicating the arithmetic operation circuit f to the homomorphic arithmetic operation unit 505. The arithmetic operation circuit f may consist of a plurality of arithmetic operation circuits.

The public parameter storage unit 502 stores the public parameter PP1 and the public parameter PP2 indicated in the data received from the input unit 501.

The encryption key storage unit 503 stores the encryption key PK1 and the encryption key PK2 indicated in the data received from the input unit 501.

The ciphertext storage unit 504 stores the ciphertext data C_PK(m1) and the ciphertext data C_PK(m2) received from the input unit 501.

The homomorphic arithmetic operation unit 505 calculates ciphertext data C_PK(M), using the arithmetic operation circuit f indicated in the data received from the input unit 501, the public parameter PP1 and the public parameter PP2 received from the public parameter storage unit 502, the encryption key PK1 and the encryption key PK2 received from the encryption key storage unit 503, and the ciphertext data C_PK(m1) and C_PK(m2) received from the ciphertext storage unit 504, and transmits the calculated ciphertext data C_PK(M) to the transmission unit 506. Here, the ciphertext data C_PK(M) is data indicating a ciphertext corresponding to arithmetic operation result data M(=f (m1, m2)) which is data indicating an arithmetic operation result obtained by applying an arithmetic operation indicated by the arithmetic operation circuit f to the plaintext data m1 and the plaintext data m2. Further, f (m1, m2) represents a result of executing the arithmetic operation indicated by the arithmetic operation circuit f with the plaintext data m1 and the plaintext data m2 which are two pieces of plaintext data, as input. Hereinafter, a homomorphic arithmetically operated ciphertext data of the arithmetic operation result data M with respect to a set {PK1, PK2} consisting of the encryption key PK1 and the encryption key PK2 will be represented as C_PK(M). C_PK(M) is also referred to as a homomorphic arithmetically operated ciphertext data. Here, the plaintext data m1 corresponds to the first plaintext. The plaintext data m2 corresponds to the second plaintext. C_PK(M) corresponds to a third ciphertext. The arithmetic operation result data M can be decrypted by using a decryption key SK1 and a decryption key SK2 for the ciphertext data C_PK(M). Here, the decryption key SK1 corresponds to the first decryption key. The decryption key SK2 corresponds to the second decryption key. The first decryption key consists of the first homomorphic decryption key and the first quantum homomorphic decryption key. The second decryption key consists of the second homomorphic decryption key and the second quantum homomorphic decryption key.

The homomorphic arithmetic operation unit 505 generates the third ciphertext by executing a quantum computation, using the first public parameter, the second public parameter, the first ciphertext, the second ciphertext, the first encryption key, and the second encryption key. Here, the third ciphertext is a ciphertext generated by encrypting an arithmetic operation result obtained by applying an arithmetic operation indicated by the arithmetic operation circuit f to the first plaintext and the second plaintext. The arithmetic operation circuit f may include each of a part that calculates a first decryption random number and a part that calculates a second decryption random number. The first decryption random number is a random number calculated based on the security parameter, the first one-time pad key, first one-time pad key ciphertext data, the first quantum homomorphic public key, and the first random number, and is a random number for decrypting the third ciphertext. The second decryption random number is a random number calculated based on the security parameter, the second one-time pad key, second one-time pad key ciphertext data, the second quantum homomorphic public key, and the second random number, and is a random number for decrypting the third ciphertext. If at least one of the first encryption key, the second encryption key, the first ciphertext, and the second ciphertext has not been generated, the homomorphic arithmetic operation unit 505 generates random quantum data, as the third ciphertext.

The homomorphic arithmetic operation unit 505 determines whether or not the first encryption key has been generated by the encryption device depending on whether or not the first decryption random number has been generated, and determines whether or not the second encryption key has been generated by the encryption device depending on whether or not the second decryption random number has been generated. The homomorphic arithmetic operation unit 505 determines whether or not the first ciphertext has been generated by the encryption device depending on whether or not the first decryption random number has been generated, and determines whether or not the second ciphertext has been generated by the encryption device depending on whether or not the second decryption random number has been generated.

The transmission unit 506 transmits to the decryption device 600, the arithmetically operated ciphertext data C_PK(M) received from the homomorphic arithmetic operation unit 505.

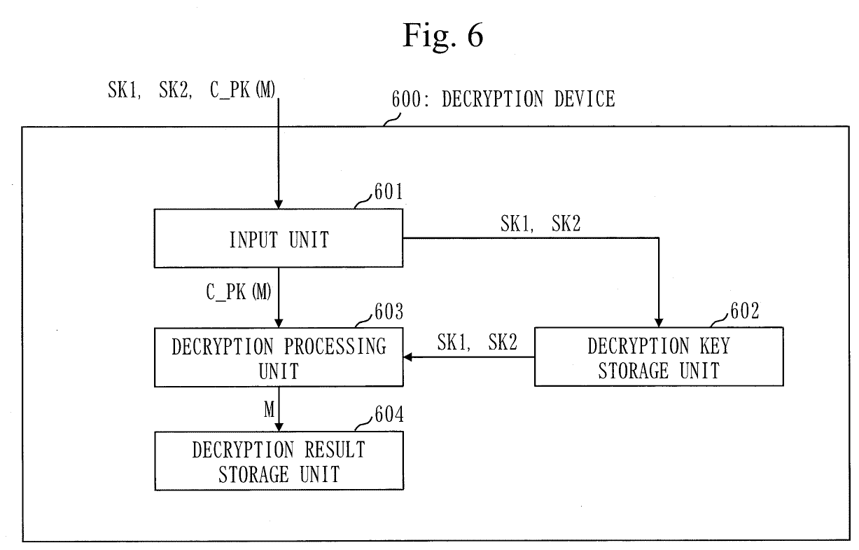

FIG. 6 is a block diagram illustrating a configuration example of the decryption device 600. The decryption device 600 includes an input unit 601, a decryption key storage unit 602, a decryption processing unit 603, and a decryption result storage unit 604, as illustrated in FIG. 6. Although it is not illustrated, the decryption device 600 includes a recording medium that stores data used in each unit of the decryption device 600.

The input unit 601 receives data indicating the decryption key SK1 and data indicating the decryption key SK2 transmitted by the key generation device 300, and transmits to the decryption key storage unit 602, the received data indicating the decryption key SK1 and the received data indicating the decryption key SK2.

Further, the input unit 601 receives the arithmetically operated ciphertext data C_PK(M) of the arithmetic operation result data M with respect to the set PK={PK1, PK2} of the encryption key transmitted by the homomorphic arithmetic operation device 500, and transmits the received arithmetically operated ciphertext data C_PK(M) to the decryption processing unit 603.

The decryption key storage unit 602 stores the decryption key SK1 and the decryption key SK2 indicated in the data received from the input unit 601.

The decryption processing unit 603 receives the arithmetically operated ciphertext data C_PK(M) from the input unit 601, receives the decryption key SK1 and the decryption key SK2 from the decryption key storage unit 602, decrypts the arithmetic operation result data M encrypted by using the decryption key SK1 and the decryption key SK2 received for the received arithmetically operated ciphertext data C_PK(M), and transmits the decrypted arithmetic operation result data M to the decryption result storage unit 604.

The decryption result storage unit 604 receives the arithmetic operation result data M from the decryption processing unit 603, and stores the received arithmetic operation result data M.

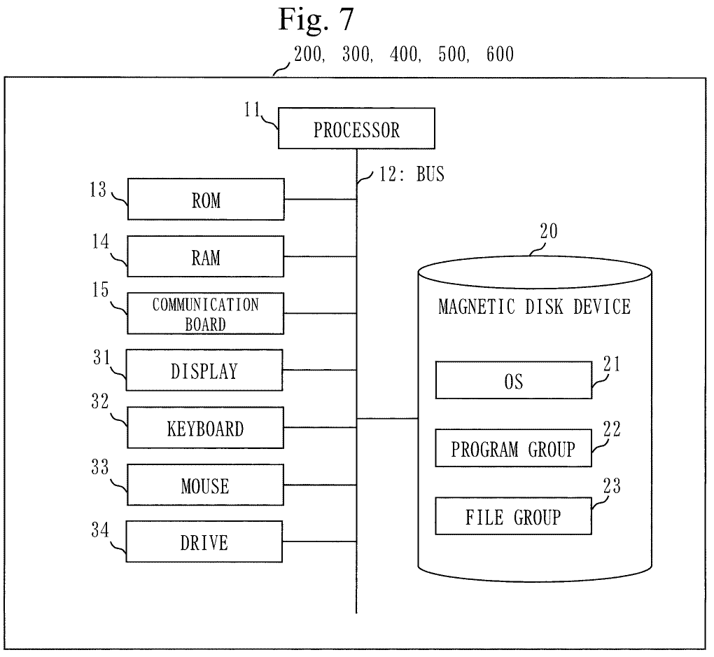

FIG. 7 is a diagram illustrating an example of hardware resources of each device according to the present embodiment. Each device is a general computer that includes a processor 11 (Central Processing Unit), as illustrated in FIG. 7.

A specific example of the processor 11 is a Central Processing Unit (CPU), a Digital Signal Processor (DSP), or a Graphics Processing Unit (GPU). The processor 11 is connected to hardware devices such as a Read Only Memory (ROM) 13, a Random Access Memory (RAM) 14, a communication board 15, a display 31 (a display device, a keyboard 32, a mouse 33, a drive 34, and a magnetic disk device 20, via a bus 12, and controls these hardware devices. The drive 34 is a device that reads and writes a storage medium such as a Flexible Disk Drive (FD), a Compact Disc (CD), and a Digital Versatile Disc (DVD).

The ROM 13, the RAM 14, the magnetic disk device 20, and the drive 34 are examples of storage devices.

The keyboard 32, the mouse 33, and the communication board 15 are examples of input devices.

The display 31 and the communication board 15 are examples of output devices.

The communication board 15 is connected by wire or wirelessly to a communication network such as a Local Area Network (LAN), the Internet, or a telephone line.

The magnetic disk device 20 stores an operating system (OS) 21, a program group 22, and a file group 23.

The program group 22 includes programs that execute functions described as each “unit” in the present embodiment. The programs are read out and executed by the processor 11. That is, the programs cause a computer to function as each “unit” and cause the computer to execute a procedure or a method of each “unit”.

The file group 23 includes various pieces of data (input, output, determination results, computation results, processing results or the like) used in each “unit” described in the present embodiment.

Processes of the present embodiment described based on the flowcharts or the like are executed using hardware such as the processor 11, a storage device, an input device, or an output device.

What is described as each “unit” may be implemented by firmware, software, hardware, or a combination thereof.

Any program described in the present specification may be recorded in a computer readable non-volatile recording medium. A specific example of the non-volatile recording medium is an optical disc or a flash memory. Any program described in the present specification may be provided as a program product.

### Description of Operation

An operational procedure of the confidential information processing system 100 is equivalent to a confidential information processing method. The confidential information processing method is also a general term for methods corresponding to the operational procedures of each of the devices that configure the confidential information processing system 100. Further, a program that implements operation of the confidential information processing system 100 is equivalent to a confidential information processing program. The confidential information processing program is also a general term for programs that implement the operations of each of the devices that configure the confidential information processing system 100.

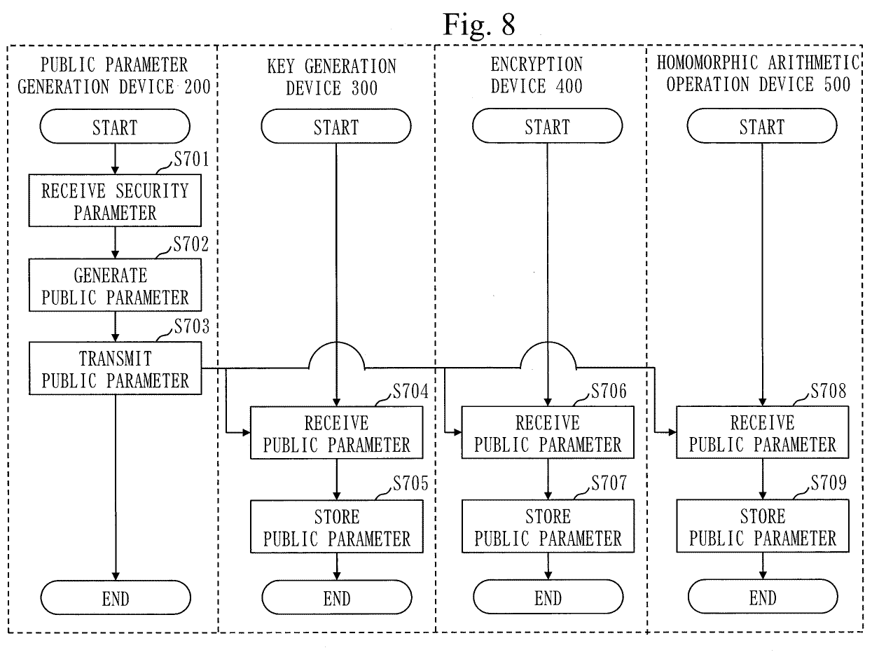

FIG. 8 is a flowchart illustrating an example of generation and storage processes of a public parameter in the confidential information processing system 100. The generation and storage processes of the public parameter will be described with reference to FIG. 8.

Steps S701 to S703 are processes executed by the public parameter generation device 200, steps S704 to S705 are processes executed by the key generation device 300, steps S706 to S707 are processes executed by the encryption device 400, and steps S708 to S709 are processes executed by the homomorphic arithmetic operation device 500.

### (Step S701)

The input unit 201 receives the security parameter λ.

### (Step S702)

The public parameter generation unit 202 takes the security parameter λ received by the input unit 201 in step S701, as input, and generates the public parameter PP.

### (Step S703)

The transmission unit 203 receives the public parameter PP generated by the public parameter generation unit 202 in step S702, and transmits data indicating the received public parameter PP to each of the key generation device 300, the encryption device 400, and the homomorphic arithmetic operation device 500.

### (Step S704)

The input unit 301 receives the data indicating the public parameter PP received by the transmission unit 203 in step S703.

### (Step S705)

The public parameter storage unit 302 stores the public parameter PP indicated in the data received by the input unit 301 in step S704.

### (Step S706)

The input unit 401 receives the data indicating the public parameter PP transmitted by the transmission unit 203 in step S703.

### (Step S707)

The public parameter storage unit 402 stores the public parameter PP indicated in the data received by the input unit 401 in step S706.

### (Step S708)

The input unit 501 receives the data indicating the public parameter PP transmitted by the transmission unit 203 in step S703.

### (Step S709)

The public parameter storage unit 502 stores the public parameter PP indicated in the data received by the input unit 501 in step S708.

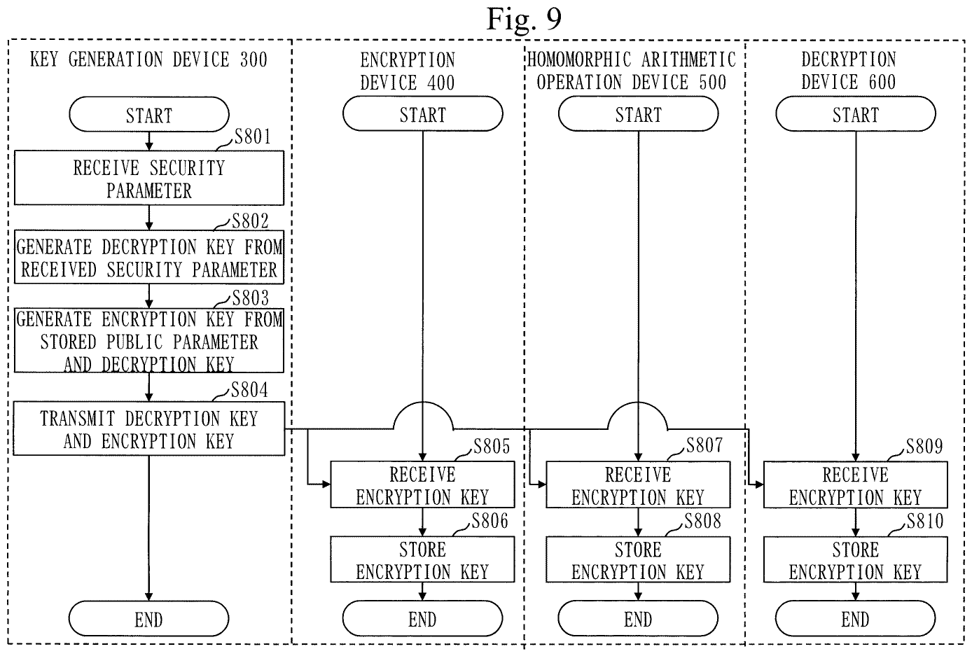

FIG. 9 is a flowchart illustrating an example of generation and storage processes of an encryption key and a decryption key in the confidential information processing system 100. The generation and storage processes of the encryption key and the decryption key will be described with reference to FIG. 9.

Steps S801 to S804 are processes executed by the key generation device 300, steps S805 to S806 are processes executed by the encryption device 400, steps S807 to S808 are processes executed by the homomorphic arithmetic operation device 500, and steps S809 to S810 are processes executed by the decryption device 600.

### (Step S801)

The input unit 301 receives the data indicating the security parameter λ.

### (Step S802)

The decryption key generation unit 303 takes the security parameter λ indicated in the data received by the input unit 301 in step S801, as input, and generates a decryption key SK expressed in a format such as [Formula 1].

$$SK = ( sk , qsk ) \qquad [ Formula 1 ]$$

Here, a homomorphic decryption key sk is generated using a homomorphic key generation algorithm described in [Reference 1] with the security parameter λ as input. Further, a quantum homomorphic decryption key qsk is generated using a quantum homomorphic key generation algorithm described in [Reference 2] with the security parameter λ and a random number r as input.

### [Reference 1]

Ostrovsky, R. et al., “Maliciously Circuit-private FHE.”, CRYPTO 2014: Advances in Cryptology-CRYPTO 2014, pp. 536-553, 2014.

### [Reference 2]

Agarwal, A. et al., “Post-Quantum Multi-Party Computation”, EUROCRYPT 2021: Advances in Cryptology-EUROCRYPT 2021, pp. 435-464, 2021.

### (Step S803)

The encryption key generation unit 304 takes the decryption key SK generated by the decryption key generation unit 303 in step S802 and the public parameter PP stored in the public parameter storage unit 302, as input, and generates the encryption key PK expressed in a format such as [Formula 2].

$$PK = ( pk , qpk , [ r ] ) \qquad [ Formula 2 ]$$

Here, a homomorphic public key pk is generated using the homomorphic key generation algorithm described in [Reference 1] with the homomorphic decryption key sk as input. A quantum homomorphic public key qpk is generated using the quantum homomorphic key generation algorithm described in [Reference 2] with the public parameter PP, the quantum homomorphic decryption key qsk, and the random number r as input. Further, a random number ciphertext [r] is generated using a homomorphic encryption algorithm described in [Reference 1] with the random number r and the homomorphic public key pk as input.

### (Step S804)

The transmission unit 305 receives the data indicating the decryption key SK generated by the decryption key generation unit 303 in step S802 and the data indicating the encryption key PK generated by the encryption key generation unit 304 in step S803, transmits the received data indicating the encryption key PK to each of the encryption device 400 and the homomorphic arithmetic operation device 500, and transmits the received data indicating the decryption key SK to the decryption device 600.

### (Step S805)

The input unit 401 receives the data indicating the encryption key PK transmitted by the transmission unit 305 in step S804.

### (Step S806)

The encryption key storage unit 403 stores the encryption key PK indicated in the data received by the input unit 401 in step S805.

### (Step S807)

The input unit 501 receives the data indicating the encryption key PK transmitted by the transmission unit 305 in step S804.

### (Step S808)

The encryption key storage unit 503 stores the encryption key PK indicated in the data received by the input unit 501 in step S807.

### (Step S809)

The input unit 601 receives the data indicating the decryption key SK transmitted by the transmission unit 305 in step S804.

### (Step S810)

The decryption key storage unit 602 stores the decryption key SK indicated in the data received by the input unit 601 in step S809.

Since the decryption key SK is secret information, the decryption key storage unit 602 needs to strictly store the decryption key SK in order to prevent the decryption key SK from being leaked to the outside.

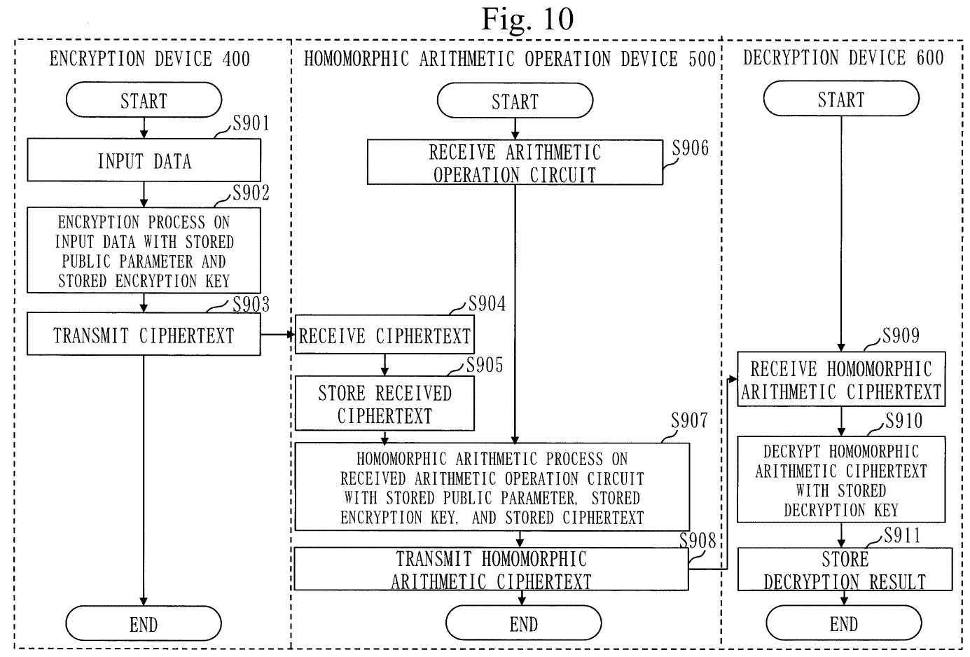

FIG. 10 is a flowchart illustrating an example of the homomorphic arithmetic operation in the confidential information processing system 100. The homomorphic arithmetic operation will be described with reference to FIG. 10.

Steps S901 to S903 are processes executed by the encryption device 400, steps S904 to S908 are processes executed by the homomorphic arithmetic operation device 500, and steps S909 to S911 are processes executed by the decryption device 600.

### (Step S901)

The input unit 401 receives the plaintext data m1 and the plaintext data m2 collected from a sensor or the like as a specific example, and transmits the received plaintext data m1 and the received plaintext data m2 to the encryption unit 404.

### (Step S902)

The encryption unit 404 generates from the plaintext data m1 and the plaintext data m2 received by the input unit 401 in step S901, the public parameter PP1 and the public parameter PP2 stored in the public parameter storage unit 402, and the encryption key PK1 and the encryption key PK2 stored in the encryption key storage unit 403, the ciphertext data C_PK(m1) and the ciphertext data C_PK(m2) expressed in a format such as [Formula 3]. The notation in a formula may differ from the notation in the present text depending on the character format that can be expressed.

$${C}_{PK} ( m 1 ) = ( c 1 , {[ [ otk 1 ] ]}_{1} , {[ otk 1 , s 1 ]}_{1} ) \qquad [ Formula 3 ]$$

$${C}_{PK} ( m 2 ) = ( c 2 , {[ [ otk 2 ] ]}_{2} , {[ otk 2 , s 2 ]}_{2} )$$

Here, quantum ciphertext data c1 and quantum ciphertext data c2 are generated using a quantum one-time pad encryption algorithm described in [Reference 2] with a one-time pad key otk1 and a one-time pad key otk2, respectively, as input. Here, the one-time pad key otk1 corresponds to the first one-time pad key. The one-time pad key otk2 corresponds to the second one-time pad key. Each of [[otk1]]_1 and [otk2]_2 which is one-time pad key ciphertext data are generated using a multi-key quantum homomorphic encryption algorithm described in [Reference 2] with the one-time pad key otk1 or the one-time pad key otk2, a quantum homomorphic public key qpk1 or a quantum homomorphic public key qpk2, and a random number s1 or a random number s2, as input. Here, the quantum homomorphic public key qpk1 corresponds to the first quantum homomorphic public key. The quantum homomorphic public key qpk2 corresponds to the second quantum homomorphic public key. Each of the public parameter PP1 and the public parameter PP2 is used as input to the multi-key quantum homomorphic encryption algorithm. Further, Each of [otk1, s1]_1 and [otk2, s2]_2 which are one-time pad keys and random number ciphertext data is generated using the homomorphic encryption algorithm described in [Reference 1] with the one-time pad key otk1 or the one-time pad key otk2, a homomorphic public key pk1 or a homomorphic public key pk2, and the random number s1 or the random number s2, as input. Here, the homomorphic public key pk1 corresponds to the first homomorphic public key. The homomorphic public key pk2 corresponds to the second homomorphic public key. The random number s1 corresponds to the first random number. The random number s2 corresponds to the second random number. The encryption unit 404 transmits each of the ciphertext data C_PK(m1) and the ciphertext data C_PK(m2) to the transmission unit 405 of the encryption device 400.

### (Step S903)

The transmission unit 405 receives the ciphertext data C_PK(m1) and the ciphertext data C_PK(m2) transmitted by the encryption unit 404 in step S902, and transmits the received ciphertext data C_PK(m1) and the received ciphertext data C_PK(m2) to the homomorphic arithmetic operation device 500.

### (Step S904)

The input unit 501 receives the ciphertext data C_PK(m1) and the ciphertext data C_PK(m2) transmitted by the transmission unit 405, and transmits the received ciphertext data C_PK(m1) and the received ciphertext data C_PK(m2) to the ciphertext storage unit 504.

### (Step S905)

The ciphertext storage unit 504 receives the ciphertext data C_PK(m1) and the ciphertext data C_PK(m2) transmitted by the input unit 501 in step S904, and stores the received ciphertext data C_PK(m1) and the received ciphertext data C_PK(m2).

### (Step S906)

The input unit 501 receives the arithmetic operation circuit f input by a keyboard, a mouse, a storage device, or the like, and transmits the received arithmetic operation circuit f to the homomorphic arithmetic operation unit 505.

### (Step S907)

The homomorphic arithmetic operation unit 505 generates the arithmetically operated ciphertext data C_PK(M) corresponding to the arithmetic operation result data M(=f (m1, m2)) corresponding to the encryption key set {PK1, PK2} expressed in the format of [Formula 4] with the arithmetic operation circuit f received from the input unit 501, the public parameter PP1 and the public parameter PP2 stored in the public parameter storage unit 502, the encryption key PK1 and the encryption key PK2 stored in the encryption key storage unit 503, and the ciphertext data C_PK(m1) and the ciphertext data C_PK(m2) stored in the ciphertext storage unit 504, as input, and transmits the generated arithmetically operated ciphertext data C_PK(M) to the transmission unit 506.

$${C}_{PK} ( M ) = ( {c}^{′} , ( c {1}^{′} , c 2 ) ) \qquad [ Formula 4 ]$$

Here, quantum homomorphic arithmetically operated ciphertext data c′ is generated by a method described in [Formula 5]. Each of c1′ and c2′ which are quantum homomorphic arithmetically operated partial ciphertext data is generated using a homomorphic arithmetic algorithm described in [Reference 1] with an arithmetic operation circuit described in [Formula 7] or [Formula 8], the homomorphic public key pk1 or the homomorphic public key pk2, random number ciphertext data [r1]_1 or random number cipher text data [r2]_2, and [otk1, s1]_1 or [otk2, s2]_2 which are one-time pad keys and random number ciphertext data, as input.

$${c}^{′} = QOTP \cdot Enc ( {otk}^{′} , {c}^{″} ) \qquad [ Formula 5 ]$$

Here, an algorithm QOTP.Enc is the quantum one-time pad encryption algorithm described in [Reference 2], and a one-time pad key otk′ is a bit string randomly selected. Further, c″ is generated using a quantum homomorphic arithmetic algorithm described in [Reference 2] with a quantum circuit G expressed by [Formula 6], the quantum homomorphic public key qpk1 and the quantum homomorphic public key qpk2, and [otk1]_1 and [otk2]_2 which are one-time pad key ciphertext data, as input. Each of the public parameter PP1 and the public parameter PP2 is used as input to the quantum homomorphic arithmetic algorithm.

$${G}_{c 1 , c 2} ( otk 1 , otk 2 ) = f ( QOTP \cdot Dec ( otk 1 , c 1 ) , QOTP \cdot Dec ( otk 2 , c 2 ) ) \qquad [ Formula 6 ]$$

Here, an algorithm QOTP.Dec is a quantum one-time pad decryption algorithm described in [Reference 2].

$${T}_{qpk 1 , {[ [ otk 1 ] ]}_{1} , {ρ}_{1}} ( r 1 , otk 1 , s 1 ) = \{ \begin{matrix}ρ 1 & if & ( \cdot , qpk 1 ) = MKQFHE \cdot Gen ( {1}^{λ} , r 1 ) \\ & and & {[ [ otk 1 ] ]}_{1} = MKQFHE \cdot Enc ( qpk 1 , otk 1 , s 1 ) \\ 0 & & otherwise\end{matrix} \qquad [ Formula 7 ]$$

$${T}_{qpk 2 , {[ [ otk 2 ] ]}_{2} , {ρ}_{2}} ( r 2 , otk 2 , s 2 ) = \{ \begin{matrix}ρ 2 & if & ( \cdot , qpk 2 ) = MKQFHE \cdot Gen ( {1}^{λ} , r 2 ) \\ & and & {[ [ otk 2 ] ]}_{2} = MKQFHE \cdot Enc ( qpk 2 , otk 2 , s 2 ) \\ 0 & & otherwise\end{matrix} \qquad [ Formula 8 ]$$

Here, algorithms MKQFHE.Gen and MKQFHE.Enc are the quantum homomorphic key generation algorithm and the quantum homomorphic encryption algorithm described in [Reference 2], respectively. Further, a random number ρ1 and a random number ρ2 are random numbers for decrypting ciphertext data, and are numbers that satisfy the relation of [Formula 9] with respect to the one-time pad key otk′. Here, [Formula 7] corresponds to the part that calculates the first decryption random number. [Formula 8] corresponds to the part that calculates the second decryption random number. The random number ρ1 corresponds to the first decryption random number. The random number ρ2 corresponds to the second decryption random number.

The homomorphic arithmetic operation unit 505 checks whether or not each of the encryption keys PK and each piece of the ciphertext data C_PK(m) are correctly generated by executing the arithmetic operation indicated by the arithmetic operation circuit f described in each of [Formula 7] and [Formula 8] while keeping the data encrypted. Here, when an encryption key that has not been generated by the key generation device 300 is used in the homomorphic arithmetic operation unit 505, the random number ρ1 and the random number ρ2 cannot be obtained in the decryption device 600 due to the configuration of the arithmetic operation circuit f described in each of [Formula 7] and [Formula 8]. Further, even when ciphertext data that has not been generated by the encryption device 400 is used in the homomorphic arithmetic operation unit 505, the random number ρ1 and the random number ρ2 cannot be obtained in the decryption device 600 in a similar manner.

$${otk}^{′} = XOR ( ρ 1 , ρ2 ) \qquad [ Formula 9 ]$$

Here, an arithmetic operation circuit XOR is a circuit that calculates a bitwise XOR of ρ1 and ρ2 which are input to the circuit.

### (Step S908)

The transmission unit 506 transmits to the decryption device 600, the arithmetically operated ciphertext data C_PK(M) transmitted from the homomorphic arithmetic operation unit 505 in step S907.

### (Step S909)

The input unit 601 receives the arithmetically operated ciphertext data C_PK(M) transmitted from the transmission unit 506 in step S908, and transmits the received arithmetically operated ciphertext data C_PK(M) to the decryption processing unit 603.

### (Step S910)

The decryption processing unit 603 obtains a decryption result M by performing a decryption process using the arithmetically operated ciphertext data C_PK(M) transmitted from the input unit 601 in step S909, and the decryption key SK1 and the decryption key SK2 stored in the decryption key storage unit 602. Here, for the encryption key set {PK1, PK2} corresponding to the arithmetically operated ciphertext data C_PK(M), the decryption processing unit 603 can decrypt the decryption result M(=f (m1, m2)) only in a case where the encryption key PK1 has been generated in the encryption key generation unit 304 with the decryption key SK1 as input, and the encryption key PK2 has been generated in the encryption key generation unit 304 with the decryption key SK2 as input.

The decryption processing unit 603 transmits the decryption result M to the decryption result storage unit 604.

### (Step S911)

The decryption result storage unit 604 stores the decryption result M transmitted by the decryption processing unit 603 in step S910.

A ciphertext to be received by the decryption device 600 is a ciphertext to which the homomorphic arithmetic operation has been applied. Therefore, when it is desired to decrypt the ciphertext before the homomorphic arithmetic operation is applied, plaintext data corresponding to the ciphertext before the homomorphic arithmetic operation is applied can be decrypted by requesting the homomorphic arithmetic operation device 500 to execute the homomorphic arithmetic operation that outputs the same value as the input itself, and decrypting in the same manner as the process in step S910, a ciphertext, to which the homomorphic arithmetic operation has been applied, obtained by executing the homomorphic arithmetic operation.

Step S911 ends homomorphic arithmetic processing of the confidential information processing system 100.

### Description of Effects of Embodiment 1

As describe above, in the present embodiment, homomorphic encryption that satisfies safe circuit confidentiality for a quantum computer is used internally. Here, each of the cryptographic techniques described in [Reference 1] and [Reference 2] has security for the quantum computer. Therefore, a quantum homomorphic encryption method that satisfies strong circuit confidentiality according to the present embodiment also has security for the quantum computer. On the other hand, since homomorphic encryption is used internally, which satisfies the circuit confidentiality that is not secure for the quantum computer, the conventional technique does not have the security for the quantum computer.

Further, since the present embodiment has the security against the quantum computer, it is possible to set a parameter more efficiently and implement an encryption method. On the other hand, since the conventional technique does not have the security for the quantum computer, it is necessary to compute a ciphertext whose size is large enough to have the security for the quantum computer.

Accordingly, according to the present embodiment, since there is no need to generate a ciphertext that is secure for a quantum computer and whose size is sufficiently large.

### Other Configurations

### Modification 1

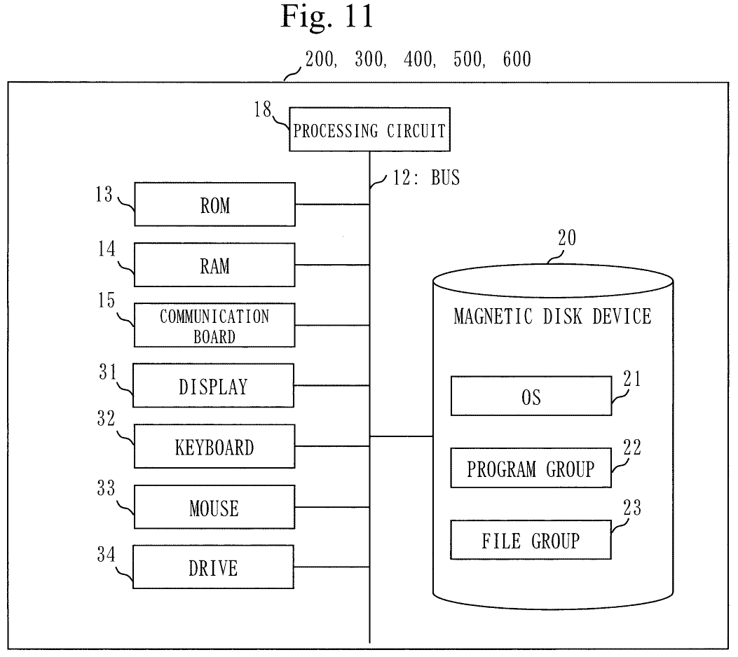

FIG. 11 illustrates a hardware configuration example of each device according to the present modification.

Each device includes a processing circuit 18 in place of the processor 11, the processor 11 and the ROM 13, the processor 11 and the RAM 14, or the processor 11, the ROM 13, and the RAM 14.

The processing circuit 18 is hardware that implements at least a part of each unit included in each device.

The processing circuit 18 may be dedicated hardware, or may be a processor that executes a program stored in the RAM 14.

When the processing circuit 18 is the dedicated hardware, a specific example of the processing circuit 18 is a single circuit, a composite circuit, a programmed processor, a parallel programmed processor, an Application Specific Integrated Circuit (ASIC), a Field Programmable Gate Array (FPGA), or a combination thereof.

Each device may include a plurality of processing circuits as an alternative to the processing circuit 18. The plurality of processing circuits share the role of the processing circuit 18.

In each device, some functions may be implemented by the dedicated hardware, and the remaining functions may be implemented by software or firmware.

The processing circuit 18 is implemented by, as a specific example, hardware, software, firmware, or a combination thereof.

The processor 11, the ROM 13, the RAM 14, and the processing circuit 18 are collectively referred to as “processing circuitry”. That is, the functions of the individual functional components of each device are implemented by the processing circuitry.

### Other Embodiments

Although Embodiment 1 has been described, a plurality of portions of the present embodiment may be implemented in combination. Alternatively, the present embodiment may be partially implemented. In addition, the present embodiment may be modified in various ways as needed, and may be implemented as a whole or in part, in any combination.

The embodiments described above are essentially preferable examples, and are not intended to limit the present disclosure, its applications, and the scope of use. The procedures described using the flowcharts and the like may be appropriately modified.

### REFERENCE SIGNS LIST

11: processor; 12: bus; 13: ROM; 14: RAM; 15: communication board; 18: processing circuit; 20: magnetic disk device; 21: OS; 22: program group; 23: file group; 31: display; 32: keyboard; 33: mouse; 34: drive; 100: confidential information processing system; 101: Internet; 200: public parameter generation device; 201: input unit; 202: public parameter generation unit; 203: transmission unit; 300: key generation device; 301: input unit; 302: public parameter storage unit; 303: decryption key generation unit; 304: encryption key generation unit; 305: transmission unit; 400: encryption device; 401: input unit; 402: public parameter storage unit; 403: encryption key storage unit; 404: encryption unit; 405: transmission unit; 500: homomorphic arithmetic operation device; 501: input unit; 502: public parameter storage unit; 503: encryption key storage unit; 504: ciphertext storage unit; 505: homomorphic arithmetic operation unit; 506: transmission unit; 600: decryption device; 601: input unit; 602: decryption key storage unit; 603: decryption processing unit; 604: decryption result storage unit.

1. A confidential information processing system conforming to a quantum homomorphic cryptographic technique that satisfies strong circuit confidentiality, the confidential information processing system comprising
an encryption device that includes processing circuitry to generate a first ciphertext by encrypting a first plaintext, using a first public parameter and a first encryption key, and to generate a second ciphertext by encrypting a second plaintext, using a second public parameter and a second encryption key, wherein
each of the first public parameter and the second public parameter is a parameter generated using a security parameter,
the first encryption key is an encryption key generated using the first public parameter and a first decryption key which is a decryption key generated using the security parameter,
the second encryption key is an encryption key generated using the second public parameter and a second decryption key which is a decryption key generated using the security parameter,
the first decryption key consists of a first homomorphic decryption key and a first quantum homomorphic decryption key,
the second decryption key consists of a second homomorphic decryption key and a second quantum homomorphic decryption key,
the first encryption key consists of a first homomorphic public key generated based on the first homomorphic decryption key and a first quantum homomorphic public key generated based on the first quantum homomorphic decryption key,
the second encryption key consists of a second homomorphic public key generated based on the second homomorphic decryption key and a second quantum homomorphic public key generated based on the second quantum homomorphic decryption key,
the first ciphertext is generated based on the first public parameter, a first one-time pad key, the first homomorphic public key, the first quantum homomorphic public key, and a first random number, and
the second ciphertext is generated based on the second public parameter, a second one-time pad key, the second homomorphic public key, the second quantum homomorphic public key, and a second random number.

2. The confidential information processing system according to claim 1 further comprising
a key generation device that includes processing circuitry to generate the first encryption key, using the first public parameter and the first decryption key, and to generate the second encryption key, using the second public parameter and the second decryption key.

3. The confidential information processing system according to claim 1 further comprising
a homomorphic arithmetic operation device that includes processing circuitry to generate a third ciphertext which is a ciphertext generated by encrypting an arithmetic operation result obtained by applying an arithmetic operation indicated by an arithmetic operation circuit to the first plaintext and the second plaintext, by executing a quantum computation, using the arithmetic operation circuit, the first public parameter, the second public parameter, the first ciphertext, the second ciphertext, the first encryption key, and the second encryption key.

4. The confidential information processing system according to claim 2 further comprising
a homomorphic arithmetic operation device that includes processing circuitry to generate a third ciphertext which is a ciphertext generated by encrypting an arithmetic operation result obtained by applying an arithmetic operation indicated by an arithmetic operation circuit to the first plaintext and the second plaintext, by executing a quantum computation, using the arithmetic operation circuit, the first public parameter, the second public parameter, the first ciphertext, the second ciphertext, the first encryption key, and the second encryption key.

5. The confidential information processing system according to claim 3, wherein
when at least one of the first encryption key, the second encryption key, the first ciphertext, and the second ciphertext has not been generated, the processing circuitry of the homomorphic arithmetic operation device generates random quantum data as the third ciphertext.

6. The confidential information processing system according to claim 4, wherein
when at least one of the first encryption key, the second encryption key, the first ciphertext, and the second ciphertext has not been generated, the processing circuitry of the homomorphic arithmetic operation device generates random quantum data as the third ciphertext.

7. The confidential information processing system according to claim 3, wherein
the arithmetic operation circuit includes each of
a part that calculates a first decryption random number which is a random number for decrypting the third ciphertext based on the security parameter, the first one-time pad key, first one-time pad key ciphertext data, the first quantum homomorphic public key, and the first random number, and
a part that calculates a second decryption random number which is a random number for decrypting the third ciphertext based on the security parameter, the second one-time pad key, second one-time pad key ciphertext data, the second quantum homomorphic public key, and the second random number,
the first one-time pad key ciphertext data is ciphertext data generated based on the first one-time pad key, the first quantum homomorphic public key, and the first random number,
the second one-time pad key ciphertext data is ciphertext data generated based on the second one-time pad key, the second quantum homomorphic public key, and the second random number, and
the processing circuitry of the homomorphic arithmetic operation device determines whether or not the first encryption key has been generated by the encryption device depending on whether or not the first decryption random number has been generated, and determines whether or not the second encryption key has been generated by the encryption device depending on whether or not the second decryption random number has been generated.

8. The confidential information processing system according to claim 4, wherein
the arithmetic operation circuit includes each of
a part that calculates a first decryption random number which is a random number for decrypting the third ciphertext based on the security parameter, the first one-time pad key, first one-time pad key ciphertext data, the first quantum homomorphic public key, and the first random number, and
a part that calculates a second decryption random number which is a random number for decrypting the third ciphertext based on the security parameter, the second one-time pad key, second one-time pad key ciphertext data, the second quantum homomorphic public key, and the second random number,
the first one-time pad key ciphertext data is ciphertext data generated based on the first one-time pad key, the first quantum homomorphic public key, and the first random number,
the second one-time pad key ciphertext data is ciphertext data generated based on the second one-time pad key, the second quantum homomorphic public key, and the second random number, and
the processing circuitry of the homomorphic arithmetic operation device determines whether or not the first encryption key has been generated by the encryption device depending on whether or not the first decryption random number has been generated, and determines whether or not the second encryption key has been generated by the encryption device depending on whether or not the second decryption random number has been generated.

9. The confidential information processing system according to claim 5, wherein
the arithmetic operation circuit includes each of
a part that calculates a first decryption random number which is a random number for decrypting the third ciphertext based on the security parameter, the first one-time pad key, first one-time pad key ciphertext data, the first quantum homomorphic public key, and the first random number, and
a part that calculates a second decryption random number which is a random number for decrypting the third ciphertext based on the security parameter, the second one-time pad key, second one-time pad key ciphertext data, the second quantum homomorphic public key, and the second random number,
the first one-time pad key ciphertext data is ciphertext data generated based on the first one-time pad key, the first quantum homomorphic public key, and the first random number,
the second one-time pad key ciphertext data is ciphertext data generated based on the second one-time pad key, the second quantum homomorphic public key, and the second random number, and
the processing circuitry of the homomorphic arithmetic operation device determines whether or not the first encryption key has been generated by the encryption device depending on whether or not the first decryption random number has been generated, and determines whether or not the second encryption key has been generated by the encryption device depending on whether or not the second decryption random number has been generated.

10. The confidential information processing system according to claim 6, wherein
the arithmetic operation circuit includes each of
a part that calculates a first decryption random number which is a random number for decrypting the third ciphertext based on the security parameter, the first one-time pad key, first one-time pad key ciphertext data, the first quantum homomorphic public key, and the first random number, and
a part that calculates a second decryption random number which is a random number for decrypting the third ciphertext based on the security parameter, the second one-time pad key, second one-time pad key ciphertext data, the second quantum homomorphic public key, and the second random number,
the first one-time pad key ciphertext data is ciphertext data generated based on the first one-time pad key, the first quantum homomorphic public key, and the first random number,
the second one-time pad key ciphertext data is ciphertext data generated based on the second one-time pad key, the second quantum homomorphic public key, and the second random number, and
the processing circuitry of the homomorphic arithmetic operation device determines whether or not the first encryption key has been generated by the encryption device depending on whether or not the first decryption random number has been generated, and determines whether or not the second encryption key has been generated by the encryption device depending on whether or not the second decryption random number has been generated.

11. The confidential information processing system according to claim 3, wherein
the arithmetic operation circuit includes each of
a part that calculates a first decryption random number which is a random number for decrypting the third ciphertext based on the security parameter, the first one-time pad key, first one-time pad key ciphertext data, the first quantum homomorphic public key, and the first random number, and
a part that calculates a second decryption random number which is a random number for decrypting the third ciphertext based on the security parameter, the second one-time pad key, second one-time pad key ciphertext data, the second quantum homomorphic public key, and the second random number,
the first one-time pad key ciphertext data is ciphertext data generated based on the first one-time pad key, the first quantum homomorphic public key, and the first random number,
the second one-time pad key ciphertext data is ciphertext data generated based on the second one-time pad key, the second quantum homomorphic public key, and the second random number, and
the processing circuitry of the homomorphic arithmetic operation device determines whether or not the first ciphertext has been generated by the encryption device depending on whether or not the first decryption random number has been generated, and determines whether or not the second ciphertext has been generated by the encryption device depending on whether or not the second decryption random number has been generated.

12. The confidential information processing system according to claim 4, wherein
the arithmetic operation circuit includes each of
a part that calculates a first decryption random number which is a random number for decrypting the third ciphertext based on the security parameter, the first one-time pad key, first one-time pad key ciphertext data, the first quantum homomorphic public key, and the first random number, and
a part that calculates a second decryption random number which is a random number for decrypting the third ciphertext based on the security parameter, the second one-time pad key, second one-time pad key ciphertext data, the second quantum homomorphic public key, and the second random number,
the first one-time pad key ciphertext data is ciphertext data generated based on the first one-time pad key, the first quantum homomorphic public key, and the first random number,
the second one-time pad key ciphertext data is ciphertext data generated based on the second one-time pad key, the second quantum homomorphic public key, and the second random number, and
the processing circuitry of the homomorphic arithmetic operation device determines whether or not the first ciphertext has been generated by the encryption device depending on whether or not the first decryption random number has been generated, and determines whether or not the second ciphertext has been generated by the encryption device depending on whether or not the second decryption random number has been generated.

13. The confidential information processing system according to claim 5, wherein
the arithmetic operation circuit includes each of
a part that calculates a first decryption random number which is a random number for decrypting the third ciphertext based on the security parameter, the first one-time pad key, first one-time pad key ciphertext data, the first quantum homomorphic public key, and the first random number, and
a part that calculates a second decryption random number which is a random number for decrypting the third ciphertext based on the security parameter, the second one-time pad key, second one-time pad key ciphertext data, the second quantum homomorphic public key, and the second random number,
the first one-time pad key ciphertext data is ciphertext data generated based on the first one-time pad key, the first quantum homomorphic public key, and the first random number,
the second one-time pad key ciphertext data is ciphertext data generated based on the second one-time pad key, the second quantum homomorphic public key, and the second random number, and
the processing circuitry of the homomorphic arithmetic operation device determines whether or not the first ciphertext has been generated by the encryption device depending on whether or not the first decryption random number has been generated, and determines whether or not the second ciphertext has been generated by the encryption device depending on whether or not the second decryption random number has been generated.

14. The confidential information processing system according to claim 6, wherein
the arithmetic operation circuit includes each of
a part that calculates a first decryption random number which is a random number for decrypting the third ciphertext based on the security parameter, the first one-time pad key, first one-time pad key ciphertext data, the first quantum homomorphic public key, and the first random number, and
a part that calculates a second decryption random number which is a random number for decrypting the third ciphertext based on the security parameter, the second one-time pad key, second one-time pad key ciphertext data, the second quantum homomorphic public key, and the second random number,
the first one-time pad key ciphertext data is ciphertext data generated based on the first one-time pad key, the first quantum homomorphic public key, and the first random number,
the second one-time pad key ciphertext data is ciphertext data generated based on the second one-time pad key, the second quantum homomorphic public key, and the second random number, and
the processing circuitry of the homomorphic arithmetic operation device determines whether or not the first ciphertext has been generated by the encryption device depending on whether or not the first decryption random number has been generated, and determines whether or not the second ciphertext has been generated by the encryption device depending on whether or not the second decryption random number has been generated.

15. A confidential information processing method conforming to a quantum homomorphic cryptographic technique that satisfies strong circuit confidentiality, the confidential information processing method comprising
generating a first ciphertext by encrypting a first plaintext, using a first public parameter and a first encryption key, and generating a second ciphertext by encrypting a second plaintext, using a second public parameter and a second encryption key, wherein
each of the first public parameter and the second public parameter is a parameter generated using a security parameter,
the first encryption key is an encryption key generated using the first public parameter and a first decryption key which is a decryption key generated using the security parameter,
the second encryption key is an encryption key generated using the second public parameter and a second decryption key which is a decryption key generated using the security parameter,
the first decryption key consists of a first homomorphic decryption key and a first quantum homomorphic decryption key,
the second decryption key consists of a second homomorphic decryption key and a second quantum homomorphic decryption key,
the first encryption key consists of a first homomorphic public key generated based on the first homomorphic decryption key and a first quantum homomorphic public key generated based on the first quantum homomorphic decryption key,
the second encryption key consists of a second homomorphic public key generated based on the second homomorphic decryption key and a second quantum homomorphic public key generated based on the second quantum homomorphic decryption key,
the first ciphertext is generated based on the first public parameter, a first one-time pad key, the first homomorphic public key, the first quantum homomorphic public key, and a first random number, and
the second ciphertext is generated based on the second public parameter, a second one-time pad key, the second homomorphic public key, the second quantum homomorphic public key, and a second random number.

16. A non-transitory computer-readable medium storing a confidential information processing program conforming to quantum a homomorphic cryptographic technique that satisfies strong circuit confidentiality, the confidential information processing program for causing an encryption device which is a computer to execute
an encryption process to generate a first ciphertext by encrypting a first plaintext, using a first public parameter and a first encryption key, and to generate a second ciphertext by encrypting a second plaintext, using a second public parameter and a second encryption key, wherein
each of the first public parameter and the second public parameter is a parameter generated using a security parameter,
the first encryption key is an encryption key generated using the first public parameter and a first decryption key which is a decryption key generated using the security parameter,
the second encryption key is an encryption key generated using the second public parameter and a second decryption key which is a decryption key generated using the security parameter,
the first decryption key consists of a first homomorphic decryption key and a first quantum homomorphic decryption key,
the second decryption key consists of a second homomorphic decryption key and a second quantum homomorphic decryption key,
the first encryption key consists of a first homomorphic public key generated based on the first homomorphic decryption key and a first quantum homomorphic public key generated based on the first quantum homomorphic decryption key,
the second encryption key consists of a second homomorphic public key generated based on the second homomorphic decryption key and a second quantum homomorphic public key generated based on the second quantum homomorphic decryption key,
the first ciphertext is generated based on the first public parameter, a first one-time pad key, the first homomorphic public key, the first quantum homomorphic public key, and a first random number, and
the second ciphertext is generated based on the second public parameter, a second one-time pad key, the second homomorphic public key, the second quantum homomorphic public key, and a second random number.
